(19) United States
(12) Patent Application Publication
(10) Pub. No.: US 2026/0098676 A1
(43) Pub. Date: Apr. 9, 2026

(54) REFRIGERATING APPLIANCE

(71) Applicant: BSH Hausgeräte GmbH, München (DE)

(72) Inventors: Prashantagouda HOSAMANI, Ulm (DE); Yalcin ÖZSOY, Heidenheim an der Brenz (DE); Ismet Berkutay ÖZTÜRK, Istanbul (TR); Ramavtar BASER, Mumbai (IN)

(21) Appl. No.: 19/352,678

(22) Filed: Oct. 8, 2025

(30) Foreign Application Priority Data
Oct. 8, 2024 (TR) 2024/013602

(51) Int. Cl. F25D 17/04; B01D 39/20; B01D 46/00; F25D 11/00

(52) U.S. Cl. CPC F25D 17/042; B01D 39/2062; B01D 46/0004; B01D 46/0009; B01D 46/0015; F25D 11/00; F25D 2323/0024

(57) ABSTRACT

A refrigerator has a storage compartment defined by a plurality of walls and a filter device. One of the walls has a through hole extending between an inner surface of the respective wall facing the storage compartment and an opposite outer surface of the respective wall. The filter device has a housing including a container, which defines an interior space and an access opening through which the interior space is accessible, and a lid, which is coupled to the container, and a filter material accommodated in the interior space. The housing is arranged such that the access opening is positioned corresponding to the through hole of the respective wall. The housing further contains a flange extending from the container, the flange is adhesively connected to the outer surface of the respective wall. The lid is movable to cover the access opening through the through hole of the respective wall.

### CROSS-REFERENCE TO RELATED APPLICATION

This application claims the priority, under 35 U.S.C. § 119, of Turkish Patent Application TR 2024/013602, filed Oct. 8, 2024; the prior application is herewith incorporated by reference in its entirety.

### FIELD AND BACKGROUND OF THE INVENTION

The present invention relates to a refrigerating appliance, in particular, to a domestic refrigerating appliance such as a refrigerator, a freezer, or a combined fridge-freezer.

In a domestic refrigerating appliance such as a refrigerator, typically, a storage compartment is provided in which goods such as food, beverages, medicine or similar are stored and cooled. Mainly to inhibit development of smells in the storage compartment, filter devices are integrated into the refrigerating appliance.

U.S. patent publication No. 2021/0131721 A1 discloses a cassette filter for a refrigerator containing a housing that defines an interior compartment for accommodating an absorber filter, and a lid which is hinge connected to the housing. The lid includes a plurality of open vents that allow air to flow between the interior compartment and an exterior environment. The housing includes, at a rear side, snap fit features for snap fitting the housing to a sidewall of a drawer or directly to a sidewall of the refrigerator. The housing is introduced into a recess formed in the respective sidewall from an interior surrounded by the respective sidewall.

International patent disclosure WO 2021/008273 A1 discloses a refrigerator in which air is circulated between a storage compartment and a refrigeration system through an air duct. The air duct is formed between a cover plate positioned within the storage compartment and a rear wall of a body defining the storage compartment. The cover plate includes an opening into which a filter device is inserted such that it protrudes into the air duct. The filter device includes a mounting seat configured in a drawer shape which holds a replaceable filter unit.

U.S. patent publication No. 2013/0015753 A1 describes a refrigerator with a filter module arranged in an opening of a rear wall of an inner liner of the refrigerator. The module includes a housing, a filter material a fan drawing air from a storage compartment of the refrigerator through a filter accommodated in the housing, and a fan configured to draw air through the filter. The housing includes opposite openings so that the fan can draw air through it. Similar filter modules are described in U.S. patent publication No. 2017/0191728 A1 and U.S. patent publication No. 2015/0033784 A1.

A further filter unit for a refrigerating appliance is described in European patent application EP 2 833 088 A2, wherein the filter unit includes filter and a cover. The filter includes a filter body removably accommodated in a holder which is snap fit to a receptacle integrally formed with an interior wall of the refrigerator. The cover is held between a front plate of the filter and the receptacle.

U.S. patent publication No. 2017/0336128 A1 discloses a refrigerator with an inner liner defining a storage compartment and a filter assembly. The inner liner includes a rear wall in which a raised portion is formed to define an air guide channel on a rear side thereof. The filter assembly includes a base snap fit to a rear side of the raised portion overlapping with an opening formed in the raised portion. A filter is inserted into the base from a front side of the raised portion through the opening, and a cover is attached to the base such that it covers the filter.

### SUMMARY OF THE INVENTION

It is one of the objects of the present invention to provide improved solutions for integrating a filter device into a refrigerating appliance. In particular, it is an object of the invention to integrate a filter device into a refrigerating appliance such that a filter material can be easily replaced, and leakage of air via the filter device can be reduced.

To this end, the present invention provides a refrigerating appliance in accordance with the independent claim. Advantageous embodiments are subject to the dependent claims and the following description, referring to the drawings.

According to a first aspect of the present invention, a refrigerating appliance, in particular, a domestic refrigerating appliance such as a refrigerator, a freezer, or a combined fridge-freezer is provided. The refrigerating appliance includes a storage compartment which is defined by a plurality of walls and a filter device. At least one of the walls comprises a through hole extending between an inner surface of the respective wall facing the storage compartment and an opposite outer surface of the respective wall. The filter device contains a housing including a container, which defines an interior space and an access opening through which the interior space is accessible, and a lid, which is coupled to the container and has multiple ventilation openings, and a filter material accommodated in the interior space of the container. The housing is arranged such that the access opening of the container is positioned corresponding to the through hole of the respective wall.

According to this aspect of the invention, the housing further contains a flange extending from the container, wherein the flange is adhesively connected to the outer surface of the respective wall. Further, the lid is movable to cover or clear the access opening of the container through the through hole of the respective wall.

According to a second aspect of the invention, a refrigerating appliance, in particular, a domestic refrigerating appliance such as a refrigerator, a freezer, or a combined fridge-freezer is provided. The refrigerating appliance includes a storage compartment, an evaporator chamber for accommodating an evaporator, an air channel for circulating air between the storage compartment and an evaporator chamber, and a filter device. The air channel is separated from the storage compartment by a wall, and the wall includes a through hole extending between an inner surface of the wall facing the storage compartment and an opposite outer surface of the wall facing the air channel. The filter device contains a housing including a container, which defines an interior space and an access opening through which the interior space is accessible, and a lid, which is coupled to the container, and a filter material accommodated in the interior space of the container. The housing is arranged such that the access opening of the container is positioned corresponding to the through hole of the wall.

According to this aspect of the invention, the housing further contains a flange extending from the container, wherein the flange is adhesively connected to the outer surface of the wall. Further, the container protrudes into the air channel and includes multiple ventilation openings to allow air flowing in the air channel entering the interior space, and the lid is movable to cover or clear the access opening of the container through the through hole of the respective wall.

It is one of the ideas of the present invention to realize a filter device of a refrigerating appliance with a housing that includes a container adhesively fixed to an outer surface of a respective wall of the appliance and a lid for closing the container which can be opened and closed from the storage compartment. In other words, the container is realized as a backing part which is fixed to a rear side or outer side of a respective wall by means of a flange. Thereby, a space saving installation of the filter device is achieved, and a filter material accommodated in the container can easily be accessed and changed from the storage compartment via a through hole of the respective wall.

The lid is coupled to the container. In particular, the lid may be movably coupled to the container. Generally, the lid is movable between a closed state in which it covers the access opening of the container, and an open state in which it at least partially clears the access opening.

According to the first aspect of the invention, the lid includes a plurality of ventilation openings to allow air from the storage compartment entering the interior space of the container where the filter is located. In this case, the container, except for the access opening, may be closed with preferably no openings. Optionally, one or more installation openings may be formed in the container. In this case, the installation openings either may be sealed by a cover or their total area may be neglectable compared to the total area of the ventilation openings of the lid. For example, the total area of the installation openings may be in a range between 0.5% and 2% of the total area of the ventilation openings of the lid. By realizing the container as a closed structure with no opening except for the access opening, or by optionally providing only small, preferably sealed installation openings, air leakage from the storage compartment through the container may be substantially reduced.

According to the second aspect of the invention, the container of the filter device protrudes into an air channel through which air is circulated between a cooling source, i.e., an evaporation chamber, and the storage compartment. In this case, the wall separates the storage compartment and the air channel. That is, the wall, which may, for example, be a rear wall of the storage compartment, with its inner surface limits the storage compartment and with its outer wall faces the air channel. Differing to the first aspect, the container is provided with a plurality of ventilation holes so that air flowing in the air channel can enter the interior space of the container where the filter is located. At the same time, the lid may be formed with preferably no openings. Thereby, air leakage at the position of the filter device from the air channel into the storage compartment may be reliably prevented.

In general, the invention further prevents air leakage bypassing the filter material through the through hole by providing the housing with a flange that protrudes from the container. The flange may be in the form of a web or collar which has a contact surface facing the outer surface of the wall. The contact surface is adhered to the outer surface. Thereby, a sealed connection is provided which reliably prevents air leakage.

According to some embodiments, the through hole may be formed in one of a sidewall, a ceiling wall, or a division plate dividing the storage compartment into sub-departments.

According to some embodiments, the refrigerating appliance may include an inner container which defines an inner space including the storage compartment. For example, the inner container may include a bottom wall and a ceiling wall opposite to the bottom wall in a vertical direction, and sidewalls extending between the bottom wall and the ceiling wall in the vertical direction, wherein the sidewalls are arranged opposite to each other in a transverse direction extending transverse to the vertical direction. Further, the inner container may comprise a container rear wall which extends between the sidewalls and between the bottom wall and the ceiling wall and delimits the inner space in a depth direction extending transverse to the vertical direction and the transverse direction. The container rear wall may form a rear wall of the storage compartment. Alternatively, a cover plate may be arranged within the inner space spaced to the container rear wall, wherein an air channel is formed between the cover plate and the container rear wall. In this case, the cover plate may form the rear wall of the storage compartment. The filter device, generally, may be positioned at a through hole in any of the above walls. Additionally, a division plate, which may extend between the opposite sidewalls may also include the through hole.

According to some embodiments, the division plate may include cover layers arranged spaced from each other and an insulating layer arranged between the cover layers, wherein the through hole is formed in one of the cover layers. Optionally, the container may protrude into a recess formed in the insulating layer.

According to some embodiments, the flange may extend along an entire circumference of the container. For example, the container may include a bottom and a circumferential wall defining the access opening. The flange may extend transverse to the circumferential wall and, optionally, may completely surround the access opening. Generally, the flange may be a closed frame. Thereby, when adhered to the outer surface of the wall, a complete circumference of the through hole of the wall can be sealed. Additionally, a reliable fixation is provided which prevents vibrational noise.

According to some embodiments, the flange may be connected to the outer surface of the respective wall by means of a double-sided adhesive tape. Thereby, installation of the filter device is eased and a reliable, air tight fixation of the container to the wall is provided.

According to some embodiments, the lid may pivotally coupled to the container. For example, the lid may be pivoted between its open and its closed position about an axis of rotation parallel to the respective wall. This further eases replacement of the filter material. Additionally, the lid may be prevented from falling off from the wall in its open state.

According to some embodiments, the lid may be coupled to pins that protrude into the interior space of the container and define a pivot axis about which the lid is pivotable. For example, the lid may comprise sockets engaged with the pins.

According to some embodiments, the lid may include a front plate, and at least two webs being arranged opposite each other and protruding from the front plate. Optionally, the filter material may be held between the webs. For example, the front plate may comprise two pairs of webs, wherein the webs of one pair extend in a first direction and the webs of the other pair extend in a second direction transverse to the first direction. The filter material which may, for example, be provided in a cubic shape may abut against the webs. Generally, the webs help to position the filter material, e.g., relative to the ventilation openings, and prevent falling off of the filter material when the lid is opened.

According to some embodiments, the lid may include a locking hook engageable with an engagement recess of the container to lock the lid in a closed state. For example, the locking hook may be elastically deformable and configured to snap fit into the engagement recess of the container. Thereby, a simple locking structure for locking the lid is provided.

According to some embodiments, the housing includes a positioning boss protruding from the flange and engaging with a positioning groove formed in the outer surface of the respective wall. The positioning boss may, for example, extend transverse to the flange. Further optionally, the positioning boss may protrude from the contact surface of the flange. The positioning groove and the positioning boss may be formed corresponding to each other. The combination of the positioning groove and the positioning boss ease a correct and precise positioning of the container relative to the through hole of the wall.

According to some embodiments, the container and the flange are integrally formed from a plastic material.

According to some embodiments, the filter material is charcoal.

The features and advantages disclosed herein in connection with one aspect of the invention are also disclosed for the respective other aspect(s) and vice versa.

Other features which are considered as characteristic for the invention are set forth in the appended claims.

Although the invention is illustrated and described herein as embodied in a refrigerating appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 schematically illustrates a plane view into a storage compartment of a refrigerating appliance according to an embodiment of the invention;

FIG. 2 is a diagrammatic, perspective, exploded view of a ceiling wall and a filter device of the refrigerator according to an embodiment of the invention;

FIG. 3 schematically illustrates a cross-sectional view of the refrigerating appliance according to another embodiment of the invention;

FIG. 4 is an exploded, perspective view of a filter device of the refrigerator according to an embodiment of the invention;

FIG. 5 is a perspective view of the filter device of FIG. 4;

FIG. 6 is a perspective of a lid of the filter device of FIG. 4;

FIG. 7 is a perspective view of a container of the filter device of FIG. 4 with a view into an interior space defined by the container;

FIG. 8 is a schematical cross-sectional view of a wall of the refrigerator according to an embodiment of the invention with the filter device of FIG. 4 being coupled to the wall, wherein the lid of the filter device is shown in an open state, and the walls of the container being shown as semi-transparent; and

FIG. 9 is a perspective view of the container of the filter device of the refrigerating appliance according to a further embodiment of the invention.

In the figures like reference signs denote like elements unless stated otherwise.

### DETAILED DESCRIPTION OF THE INVENTION

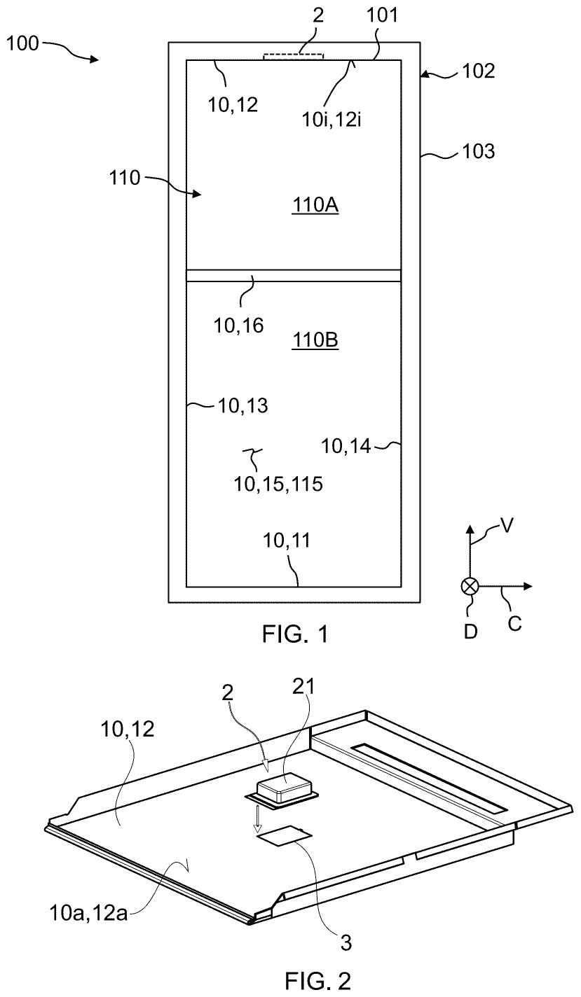

Referring now to the figures of the drawings in detail and first, particularly to FIG. 1 thereof, there is shown a reference appliance 100 in the form of a refrigerator. The present invention is not limited to a refrigerator but may be employed in any domestic refrigerating appliance 100 such as in a refrigerator, a freezer, or a combined fridge-freezer.

Generally, the refrigerating appliance 100 may include a body 102 defining an inner space in which a storage compartment 110 is provided. The storage compartment 110 is defined by multiple walls 10. For example, the storage compartment 110 may be defined by a bottom wall 11 and a ceiling wall 12 positioned opposite to the bottom wall 11 in a vertical direction V, sidewalls 13, 14 that extend in the vertical direction V between the bottom wall 11 and the ceiling wall 12 and that are positioned opposite to each other in a transverse direction C extending transverse to the vertical direction, and a rear wall 15 that extends between the sidewalls 13, 14 in the transverse direction C. The rear wall 15 limits the storage compartment 110 in a depth direction D. The rear wall 15 may extend between the bottom wall 11 and the ceiling wall 12.

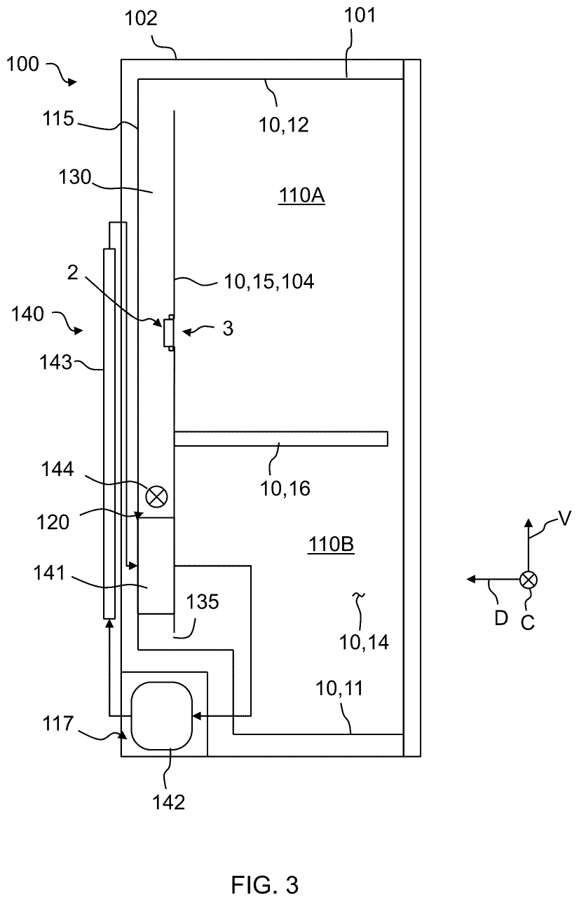

It may be provided that the body 102 includes an inner liner or inner container 101 that includes the walls 10 that define the storage compartment 110. Specifically, also the rear wall 15 of the storage compartment 110 may be defined by a rear wall 115 of the inner container 101, as exemplarily shown in FIG. 1. Alternatively, as exemplarily shown in FIG. 3, the rear wall 15 that limits the storage compartment 110 in a depth direction D may also be formed by a cover plate 104 which is arranged opposite or spaced to the rear wall 115 of the inner container 101. An air channel 130, which function will be explained in more detail below, may optionally be formed between the cover plate 104 and the rear wall 115 of the inner container 101.

A further wall 10 may be formed by a division plate 16 which divides the storage compartment 110 into sub-departments 110A, 110B. As exemplarily shown in FIG. 1, the division plate 16, for example, may extend between the sidewalls 13, 14 so that it divides the storage compartment 110 with respect to the vertical direction V.

The body 102 may include an external or outer housing 103 surrounding the inner container 101. A thermal insulation may be provided between the outer housing 103 and the inner container 101.

A refrigerant circuit (not shown in FIG. 1) may be provided for cooling the storage compartment 110. Generally, the refrigerant circuit may be configured to withdraw heat from the storage compartment by evaporation of a coolant and dissipate the heat to the environment by condensation of the coolant. FIG. 3, schematically, shows a refrigerant circuit 140 including an evaporator 141, a compressor 142, and a condenser 143.

The evaporator 141 is thermally coupled to the storage compartment. For example, a fan 144 may be provided which circulates air between the storage compartment 110 and an evaporator chamber 120, in which the evaporator 141 is accommodated. For example, the air may be transported through the air channel 130 into the storage compartment 110 and sucked from the storage compartment 110 through a suction opening 135. The air circulated between the storage compartment and the evaporator chamber 120 absorbs heat in the storage compartment 110 and discharges the heat to the refrigerant in the evaporator 141, whereby the refrigerant evaporates.

The compressor 142, with a suction interface, is connected to the evaporator 141 and, with a pressure interface, is connected to the condenser 143. The compressor 142 is configured to suck the evaporated refrigerant from the evaporator 141, compress it and supply the compressed, gaseous refrigerant to the condenser 143 where it condenses and discharges heat to the environment. The compressor 142, for example, may be positioned in a machine compartment 117 which is separated from the storage compartment, as exemplarily shown in FIG. 3.

From the condenser 143, the refrigerant is conducted again to the evaporator 141, wherein a throttle (not shown), such as a capillary tube or a valve, is positioned between the condenser 143 and the evaporator 141 to expand the refrigerant.

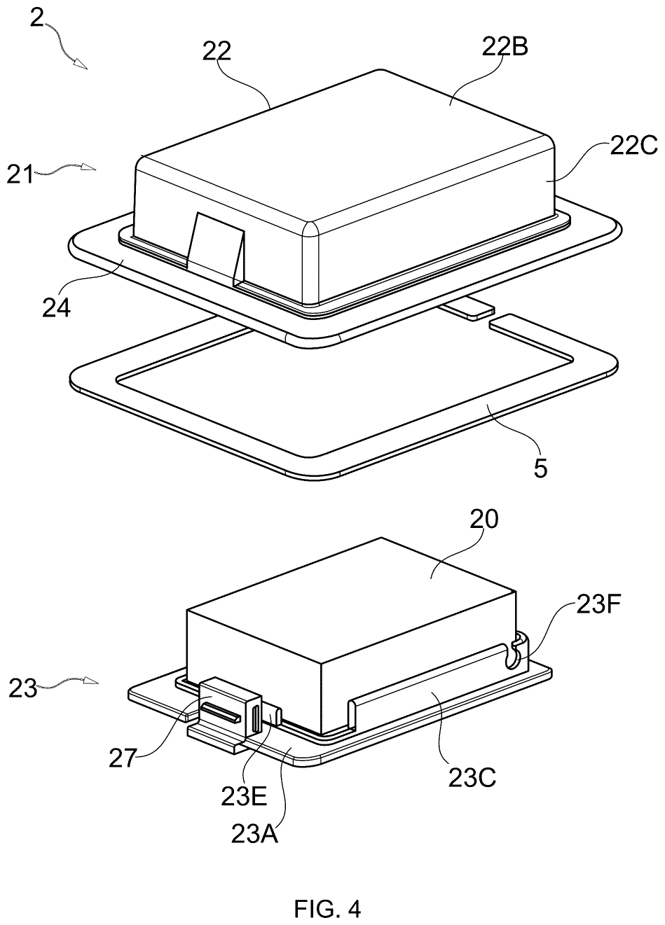

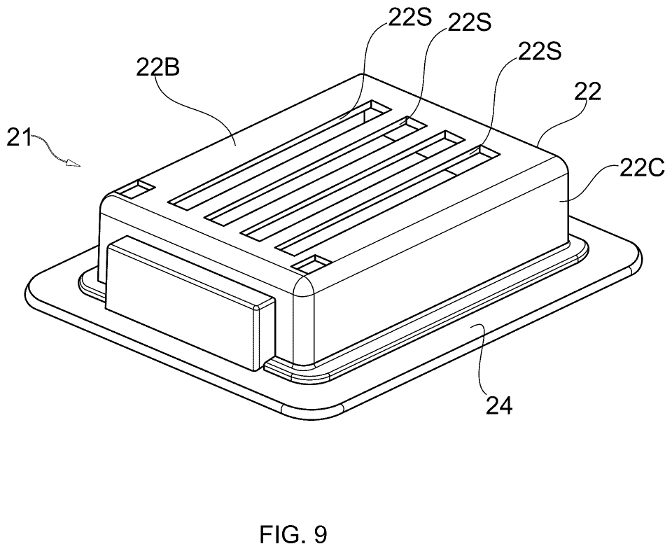

As schematically shown in FIGS. 1 and 3, the refrigerating appliance 100 further includes a filter device 2. The filter device 2 is provided to filter air being present in the storage compartment 110 or to filter air flowing in the air channel 130. FIGS. 4 to 7 exemplarily show a filter device 2 which is configured to filter air being present in the storage compartment 110. FIG. 9 exemplarily shows a filter device which is configured to filter air flowing in the air channel 130. As will become apparent from the following description, the overall configuration of the filter device 2 is identical for both locations of application. Therefore, the filter device will be explained in general by referring to FIGS. 4 to 7 and 9 in common and only the differences will be pointed out.

As shown in FIG. 4, the filter device 2 includes a filter material 20 and a housing 21. The filter material 20 may, for example, be a charcoal material. Generally, the filter material 20 may have a cubic shape as exemplarily shown in FIG. 4. As shown in FIGS. 4 and 9, the housing 21 includes a container 22, a lid 23 and a flange 24.

The container 22, generally, defines an interior space for accommodating the filter material 20. For example, the container 22 may comprise a bottom 22B, which may, for example, be plate shaped, and a circumferential wall 22C extending from the bottom 22B and defining an access opening 22A through which the interior space is accessible. As exemplarily shown in FIGS. 4, 5, 7, and 9, the circumferential wall 22C may define a rectangular circumference.

The flange 24 protrudes from the container 22. For example, the flange 24 may be realized in the form of a web that laterally protrudes from the circumference of the container 22. As exemplarily shown in FIGS. 4, 5, 7, and 9, the flange 24 may protrude from the circumferential wall 22C of the container 22. Optionally, the flange 24 may be arranged adjacent to an end of the circumferential wall 22C facing away from the bottom 22B of the container 22. The flange 24 may extend along the entire circumference of the container 22. As exemplarily shown in FIGS. 4, 5, 7, and 9, the flange 24, for example, may be realized as closed frame which surrounds the access opening 22A of the container 22. Generally, the flange 24 may have a contact surface 24a facing away from the bottom 22B of the container 22. The contact surface 24a may be planar. Optionally, a positioning boss 28 may be formed protruding from the flange 24. For example, the positioning boss 28 may protrude from the contact surface 24a of the flange 24 as exemplarily shown in FIG. 5.

The container 22 and the flange 24, for example, may be integrally formed from a plastic material.

As shown in FIG. 5, the filter material 20 is accommodated in the interior space defined by the container 22.

The lid 23 is coupled to the container 22 and provided for closing the access opening 22A. Generally, the lid 23 may be movably coupled to the container 22. Specifically, the lid 23 may be movable between a closed position in which it covers the access opening 22A, and an open position in which it at least partially clears the access opening 22A so that the filter material 20 can be removed from the interior space of the container 22. FIG. 5 shows the lid 23 positioned in the closed position, FIG. 8 shows the lid 23 being positioned in the open position.

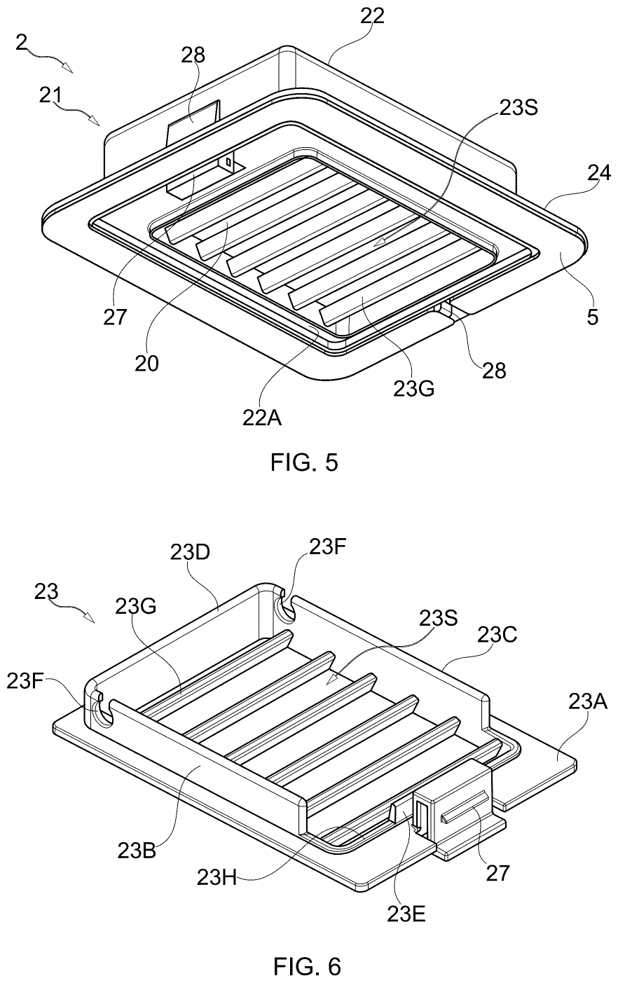

As exemplarily shown in FIG. 6, the lid 23 may comprise a front plate 23A dimensioned to cover the access opening 22A. Optionally, the lid 23 may further include at least two webs 23B-E protruding from the front plate 23A and being positioned opposite to each other. For example, a pair of first webs 23B, 23C may be provided which are positioned opposite to each other in a first direction. Additionally, or alternatively, a pair of second webs 23D, 23E may be provided which are positioned opposite to each other in a second direction extending transverse to the first direction. FIG. 6 exemplarily shows a lid having a pair of first webs 23B, 23C and a pair of second webs 23D, 23E, wherein the webs 23B, 23C, and 23D are connected to each other and form three sides of a rectangle, while the web 23E is positioned separated. The webs 23B-E serve to hold the filter material 20 therebetween. Generally, the webs 23B-E may be arranged to surround the filter material 20.

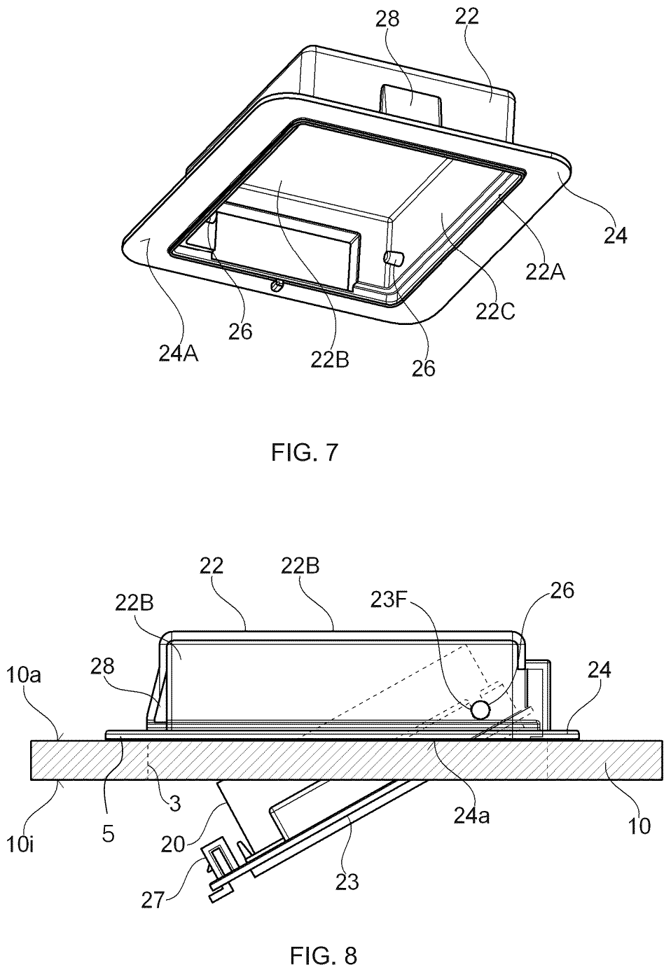

The lid 23 may be pivotally coupled to the container 22. For example, a pivot joint may be formed by pins 26 that protrude into the interior space of the container 22, and recesses or receptacles 23F formed in the lid 23 and engaging the pins. The pins 26 may, for example, protrude from the circumferential wall 22C of the container 22, as shown in FIG. 7. The receptacles 23F may, for example, be formed in the first webs 23B, 23C of the lid as shown in FIG. 6. Generally, the receptacles 23F may be formed in an end portion of the lid 23. The pins 26 define a pivot axis about which the lid 23 is pivotable between its closed position and its open position.

The lid 23 may be locked in the closed position. Generally, a locking device may be provided to lock the lid in the closed position. For example, the lid 23 may include a locking hook 27 which is configured to engage with an engagement recess 28 of the container 22 to lock the lid 23 in the closed position. The locking hook 27 may, for example, be arranged in an end portion of the front plate 23A of the lid 23, preferably opposite to the receptacles 23F. The locking hook 27 may be configured to be elastically deformable relative to the lid 23, in particular, relative to the front plate 23A so that it can snap fit into the correspondingly shaped engagement recess 28 of the container 22. As depicted in FIG. 7, the engagement recess 28 of the container 22 may be formed in the circumferential wall 22C.

The housing 21 of the filter device 2 is arranged on one of the walls 10 defining the storage compartment 110. In particular, the walls 10 include an inner surface 10i facing the storage compartment 110, and an outer surface 10a oriented opposite to the inner surface 10i and facing away from the storage compartment 110. In the wall 10 at which the filter device 2 is arranged, a through hole 3 is formed which extends between the inner surface 10i and the outer surface 10a. FIG. 2, by way of example only, shows the ceiling wall 12 comprising a through hole 3 extending between the inner surface 12i and the outer surface 12a of the ceiling wall 12.

As further indicated in FIG. 2 and shown in some more detail in FIG. 8, the housing is arranged such that the access opening 22A of the container 22 is positioned corresponding to the through hole 3 of the respective wall 10. Thus, the interior space defined by the container 22 can be accessed through the through hole 3 formed in the wall 10. As shown, in particular, in FIG. 8, the housing 21 is positioned such that the contact surface 24a of the flange faces the outer surface 10a of the wall 10. Specifically, the flange 24 being adhesively connected to the outer surface 10a of the respective wall 10, for example, by means of a double-sided adhesive tape 5. The positioning boss 28 formed in the flange 24 may be placed such that it engages a positioning groove (not shown) formed in the outer surface 10a of the respective wall 10.

As further shown in FIG. 8, the lid 23 is movable between the open and closed position to clear or cover the access opening 22A of the container 22 through the through hole 3 of the respective wall 10. Since the flange 24 is adhered to the outer surface 10a of the wall 10, the access opening 22A of the container 22 faces the storage compartment 110. Consequently, the filter material 20 can easily be removed and replaced from the storage compartment.

Although FIG. 2 exemplarily shows that the through hole 3 at which the filter device 2 is placed is formed in the ceiling wall 12, it may also be formed in any other of the walls 10, e.g., in one of the sidewalls 13, 14, the ceiling wall 12, or the division plate 16. It is also possible to form the through hole 3 in the rear wall 15, i.e., in the cover plate 104 or in the rear wall 115 of the inner container 101.

As already indicated above, according to one aspect of the invention, the filter device 2 is configured to filter air being present in the storage compartment 110. According to this aspect, air from the storage compartment diffuses into the interior space of the container 22 through the through hole 3 and through ventilation openings 23S formed in the lid 23, and the container 22 preferably is configured with closed walls that are, preferably, void of any openings.

As exemplarily shown in FIGS. 5 and 6, the ventilation openings 23S may be formed in the front plate 23A of the lid 23. For example, the front plate 23A may include a central opening 23H, and a plurality of fins 23G may extend between opposite circumferential portions of the central opening 23H, wherein the ventilation openings 23S are defined between the fins 23G. The fins 23G advantageously help to support the filter material 20.

As shown in FIG. 4, the bottom 22B and the circumferential wall 22C of the container 22 may be formed with continuous walls that do not have openings. Since the flange 24 is adhesively connected to the outer surface 10a of the wall 10, an air tight design is realized that avoids or at least reduces leakage of air from the storage compartment 110. On the other hand, insulating material that may surround the container 22 is prevented from entering the interior space of the container 22 or the storage compartment 110.

According to another aspect of the invention, the filter device 2 is configured to filter air flowing in the air channel 130. In this case, the wall 10, at which the filter device 2 is arranged, may be formed, for example, by the cover plate 104 which, at the same time, may form the rear wall 15 of the storage compartment 110. According to this aspect, the container 22 is arranged such that it protrudes into the air channel 130, as exemplarily and only schematically shown in FIG. 3. Further, as exemplarily shown in FIG. 9, the container 22 includes multiple ventilation openings 22S to allow air flowing in the air channel 130 to enter the interior space defined by the container 22. Additionally, the lid 23 preferably does not have any ventilation openings. For example, the front plate 23A of the lid 23, in this case, may be massif and form a continuous wall or plate that completely covers the access opening 22A. Since the flange 24 is adhesively fixed to the outer surface 10a of the wall 10, an airtight design is realized which prevents air leaking into the storage compartment 110 from the air channel 130 through the filter device 2 and/or the through hole 3. Further, as the access opening 22A of the container 22 also in this configuration faces the storage compartment 110, the internal space of the container 22 can easily be accessed by opening the lid 23 which eases replacing the filter material 20.

As exemplarily shown in FIG. 9, ventilation openings 22S may be formed in the bottom 22B of the container 22. For example, the ventilation openings 22S may be realized as longitudinal openings or slits as exemplarily shown in FIG. 9. However, the invention is not limited to this configuration.

Although specific embodiments have been illustrated and described herein, it will be appreciated by those of at least ordinary skill in the art that a variety of alternate and/or equivalent implementations exist. It should be appreciated that the exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

The following is a summary list of reference numerals and the corresponding structure used in the above description of the invention:
2 filter device
3 through hole
5 double-sided adhesive tape
10 walls
10 multiple walls
10 wall
10a outer surface of wall
10i inner surface of wall
11 bottom wall
12 ceiling wall
12a outer surface of ceiling wall
12i inner surface of ceiling wall
13, 14 sidewalls
15 rear wall of the storage compartment
16 division plate
20 filter material
21 housing
22 container
22A access opening
22B bottom
22C circumferential wall
22S, 23S ventilation openings
23 lid
23A front plate
23B, 23C first webs
23D, 23E second webs
23F receptacles
23G fins
23H central opening
24 flange
24a contact surface
26 pins
27 locking hook
28 engagement recess
28 positioning boss
100 refrigerating appliance
100 domestic refrigerating appliance
100 reference appliance
101 inner container
102 body
103 outer housing
104 cover plate
110 storage compartment
110A, 110B sub-departments
115 rear wall of inner container
117 machine compartment
120 evaporation chamber
130 air channel
135 suction opening
140 refrigerant circuit
141 evaporator
142 compressor
143 condenser
144 fan

1. A refrigerating appliance, comprising:
a plurality of walls defining a storage compartment, at least one of said walls having a through hole formed therein and extending between an inner surface of said at least one wall facing said storage compartment and an opposite outer surface of said at least one wall; and
a filter device, containing:
a housing having a container defining an interior space and an access opening and through said access opening said interior space is accessible, and a lid, which is coupled to said container and has multiple ventilation openings formed therein;
a filter material accommodated in said interior space of said container;
said housing is disposed such that said access opening of said container is positioned corresponding to said through hole of said at least one wall;
said housing further having a flange extending from said container, said the flange being adhesively connected to said outer surface of said at least one wall; and
said lid is movable to cover or clear said access opening of said container through said through hole of said at least one wall.

2. The refrigerating appliance according to claim 1, wherein said at least one wall is a sidewall, a ceiling wall, or a division plate dividing said storage compartment into sub-departments, said through hole is formed in one of said sidewall, said ceiling wall, or said division plate dividing said storage compartment into said sub-departments.

3. The refrigerating appliance according to claim 1, wherein said flange extends along an entire circumference of said container.

4. The refrigerating appliance according to claim 1, further comprising double-sided adhesive tape, said flange is connected to said outer surface of said at least one wall by means of said double-sided adhesive tape.

5. The refrigerating appliance according to claim 1, wherein said lid is pivotally coupled to said container.

6. The refrigerating appliance according to claim 5, further comprising pins, said lid is coupled to said pins that protrude into said interior space of said container and define a pivot axis about which said lid is pivotable.

7. The refrigerating appliance according to claim 1, wherein:
said lid has a front plate, and at least two webs being disposed opposite each other and protruding from said front plate; and
said filter material is held between said at least two webs.

8. The refrigerating appliance according to claim 1, wherein:
said container has an engagement recess formed therein; and
said lid has a locking hook engageable with said engagement recess to lock said lid in a closed state.

9. The refrigerating appliance according to claim 1, wherein:
said outer surface has a positioning groove formed therein; and
said housing has a positioning boss protruding from said flange and engaging with said positioning groove formed in said outer surface of said one wall.

10. A refrigerating appliance, comprising:
walls defining a storage compartment;
an evaporator chamber for accommodating an evaporator;
an air channel for circulating air between said storage compartment and said evaporator chamber, said air channel being separated from said storage compartment by one of said walls, and said one wall having a through hole formed therein and extending between an inner surface of said one wall facing said storage compartment and an opposite outer surface of said one wall facing said air channel; and
a filter device, comprising:
a housing having a container, which defines an interior space and having an access opening formed therein and through said access opening said interior space is accessible, and a lid, which is coupled to said container;
a filter material accommodated in said interior space of said container;
said housing is disposed such that said access opening of said container is positioned corresponding to said through hole of said one wall;
said housing further having a flange extending from said container, said flange being adhesively connected to said outer surface of said one wall;
said container protrudes into said air channel and has multiple ventilation openings formed therein to allow air flowing in said air channel to enter said interior space; and
said lid is movable to cover or clear said access opening of said container through said through hole of said one wall.

11. The refrigerating appliance according to claim 10, wherein said flange extends along an entire circumference of said container.

12. The refrigerating appliance according to claim 10, further comprising double-sided adhesive tape, said flange is connected to said outer surface of said one wall by means of said double-sided adhesive tape.

13. The refrigerating appliance according to claim 10, wherein said lid is pivotally coupled to said container.

14. The refrigerating appliance according to claim 13, further comprising pins, said lid is coupled to said pins that protrude into said interior space of said container and define a pivot axis about which said lid is pivotable.

15. The refrigerating appliance according to claim 10, wherein:
said lid has a front plate, and at least two webs being disposed opposite each other and protruding from said front plate; and
said filter material is held between said at least two webs.

16. The refrigerating appliance according to claim 10, wherein:
said container has an engagement recess formed therein; and
said lid has a locking hook engageable with said engagement recess to lock said lid in a closed state.

17. The refrigerating appliance according to claim 10, wherein:
said outer surface has a positioning groove formed therein; and
said housing has a positioning boss protruding from said flange and engaging with said positioning groove formed in said outer surface of said one wall.

18. The refrigerating appliance according to claim 10, wherein said container and said flange are integrally formed from a plastic material.

19. The refrigerating appliance according to claim 10, wherein said filter material is charcoal.

20. The refrigerating appliance according to claim 10, wherein the refrigerating appliance is a domestic refrigerating appliance.
